(19) United States
(12) Patent Application Publication
(10) Pub. No.: US 2023/0286233 A1
(43) Pub. Date: Sep. 14, 2023

(54) OPTICAL MODULE PRODUCTION

(71) Applicant: ams-OSRAM Asia Pacific Pte. Ltd., Singapore (SG)

(72) Inventors: QiChuan Yu, Singapore (SG); Kam Wah Leong, Singapore (SG); Kyaw Oo Aung, Singapore (SG); Yoong Kheng Teoh, Singapore (SG); Sung Hoe Hng, Singapore (SG)

(21) Appl. No.: 18/040,016

(22) PCT Filed: Sep. 23, 2021
(86) PCT No.: PCT/SG2021/050575

§ 371 Date: Jan. 31, 2023

(30) Foreign Application Priority Data
Oct. 2, 2020 (GB) 2015637.8

(51) Int. Cl. B29D 11/00

(52) U.S. Cl. CPC B29D 11/00538; B29D 11/00298

(57) ABSTRACT

A method of producing optical modules comprising transferring liquid polymer to a lens mold array by dipping an array of fingers of a transfer device into a liquid polymer, bringing the array of fingers into proximity with recesses of the lens mold array so that the liquid polymer is received in the recesses, then separating the array of fingers and the lens mold array so that liquid polymer is retained in the recesses, and forming lenses on optical devices by bringing the lens mold array into proximity with the array of optical devices so that the liquid polymer contacts a surface of the optical devices, and curing the liquid polymer to form the lenses on the optical devices.

### TECHNICAL FIELD OF THE DISCLOSURE

The present disclosure relates to fabrication of optical modules, particularly but not exclusively, to fabrication of optical modules which combine an optical emitter and an optical sensor, and optical modules which comprise an optical sensor without an optical emitter.

### BACKGROUND OF THE DISCLOSURE

The present disclosure relates to production of optical modules which comprise a lens or lenses on an optical device. The optical device may for example be an optical sensor device (which may have a single lens), or an optical device which has an optical emitter and an optical sensor (which may have two lenses).

Optical modules are used in smartphones and other devices for various applications. For example, an ambient light sensor optical module may be used to monitor the level of ambient light to allow the display of a smartphone or other device to be adjusted accordingly. In another example, a proximity sensor module which comprises an emitter and a sensor may be used to determine the distance between a smartphone or other device and a user or other object. Other sensing modules may be used to sense other parameters. An optical emitter may be provided as part of a combined emitter and sensor optical module, or may be a separate optical module.

An optical module is conventionally provided with a lens located over an emitter or a sensor. Where the optical device is a sensor, light passes through the lens and is then incident upon the sensor, thereby allowing the sensor to perform its function. When the optical device is an emitter the lens modifies light emitted by the emitter (e.g. reducing divergence of the light). The light may be incident upon a user or object and then be incident upon a sensor (thereby allowing the proximity of the user or object to be determined).

The performance of the sensors and emitters is determined in part by the quality of the lenses. In this context quality may refer to the extent to which the shape of a lens corresponds with an intended desired shape (desired size and height, and uniformity of shape).

Fabrication of optical modules can be challenging because it is desirable to mass-produce optical modules in a cost-effective manner whilst at the same time providing optical modules which provide a desired level of performance. In particular, it may be difficult and time consuming to provide lenses on optical devices. Optical devices are becoming smaller and thus have a higher density during fabrication. There is a corresponding increase in the density of lenses during fabrication. This makes it even more difficult and time consuming to provide lenses on optical devices.

It is therefore an aim of the present disclosure to address one or more of the problems above, or another problem associated with the prior art.

### SUMMARY

In general, this disclosure proposes to overcome the above problems by using an array of fingers to deposit liquid polymer into an array of molds simultaneously, so that the molds can be positioned over optical devices and the liquid polymer cured to form solid lenses on the devices. This method is advantageous compared with prior art methods which involve depositing liquid polymer into each mold separately using injection techniques because it allows for faster production. In addition, the method eliminates or reduces variation between properties of the liquid polymer as distributed across the mold array when the mold array is positioned over the optical devices. This in turn reduces undesirable variation between the lenses formed on the optical devices. The variation between lenses formed on conventional optical devices may for example mean that when opaque polymer is applied to the optical device and lens, an aperture formed around the lens may be too small (causing poor performance). This problem may be avoided by embodiments of the disclosure.

According to one aspect of the present disclosure, there is provided a method of producing optical modules comprising transferring liquid polymer to a lens mold array by dipping an array of fingers of a transfer device into a liquid polymer, bringing the array of fingers into proximity with recesses of the lens mold array so that the liquid polymer is received in the recesses, then separating the array of fingers and the lens mold array so that liquid polymer is retained in the recesses, and forming lenses on optical devices by bringing the lens mold array into proximity with the array of optical devices so that the liquid polymer contacts a surface of the optical devices, and curing the liquid polymer to form the lenses on the optical devices.

Advantageously this allows for faster production compared with prior art methods which involve depositing liquid polymer into each mold separately using injection techniques.

The method may further comprise transferring the liquid polymer to the lens mold array multiple times before forming the lenses on the optical devices.

The transfer of liquid polymer may be performed for a series of three or more times.

When the array of fingers are in proximity with recesses of the lens mold array, there may be a gap of at least 40 microns between ends of the fingers and uppermost surfaces of the recesses.

When the array of fingers are in proximity with recesses of the lens mold array, there may be a gap of up to 200 microns between ends of the fingers and uppermost surfaces of the recesses.

When the array of fingers are in proximity with recesses of the lens mold array, there may be a gap between ends of the fingers and uppermost surfaces of the recesses. For a given transfer, the gap between ends of the fingers and uppermost surfaces of the recesses is larger than for a preceding transfer. The gap may be at least 20 microns greater than the preceding gap.

When the array of fingers are in proximity with recesses of the lens mold array, there may be a gap between ends of the fingers and uppermost surfaces of the recesses. For each transfer of the series of transfers, the gap between ends of the fingers and uppermost surfaces of the recesses may be larger than for the preceding transfer of the series. The size of the gap may be increased by a larger amount for each transfer of the series, compared with the size of the gap for the preceding transfer of the series. This advantageously allows the heights of peaks of liquid polymer which project out of the recesses to be increased.

When the transfer of liquid polymer has been completed, the liquid polymer may project beyond uppermost surfaces of the recesses of the lens mold array by at least 80 microns.

The array of fingers may be a two dimensional array.

The array of fingers may comprise at least one thousand fingers.

Distal ends of the fingers may have flat surfaces.

The fingers may be cylindrical in cross-section.

The fingers may have a maximum cross-sectional dimension of 1000 microns or less. The fingers may have a diameter of 1000 microns or less.

The fingers may be separated by a separation of 5 mm or less.

The fingers may be provided in pairs. A separation between fingers which comprise a pair may be 1000 microns or less.

The fingers may be provided in pairs, with one finger of a pair having a distal end at a different height than the other finger of the pair.

The fingers may be provided in pairs, with one finger of a pair having a greater maximum cross-sectional diameter than the other finger of the pair.

The liquid epoxy may be clear glue.

The method may further comprises= injecting an opaque polymer into spaces around the devices to form covers for the devices with apertures around the lenses, then dicing the opaque polymer covers to form packaged optical modules.

According to a second aspect of the invention there is provided a liquid polymer transfer device comprising a substrate provided with a two dimensional array of fingers which project from a substrate and further comprising a plurality of alignment marks provided in the substrate.

According to a third aspect of the invention there is provided an optical module comprising an optical device provided with a lens formed according to the method of the first aspect.

There may be no overspill of cured polymer on sides of the optical device of the optical module.

Features of different aspects of the invention may be combined together.

Finally, the method disclosed here utilizes a novel approach at least in that an array of molds are filled with liquid polymer in parallel using an array of fingers which carry liquid polymer at the ends of the fingers.

### BRIEF DESCRIPTION OF THE PREFERRED EMBODIMENTS

Some embodiments of the disclosure will now be described by way of example only and with reference to the accompanying drawings, in which:

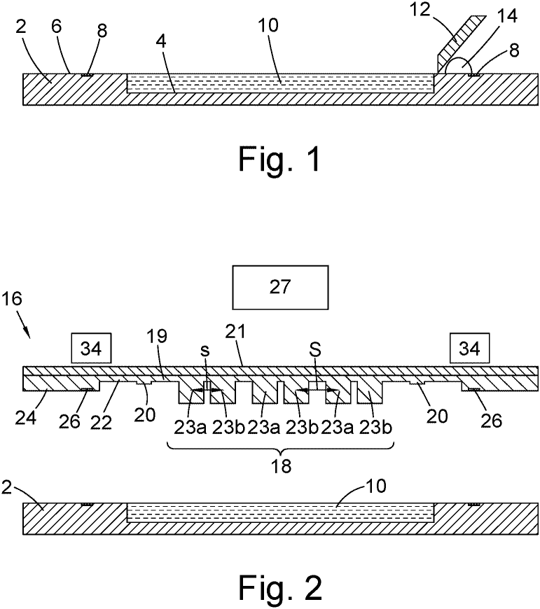

FIG. 1 schematically depicts in cross-section a tray filled with liquid polymer;

FIG. 2 schematically depicts in cross-section a transfer device positioned above the tray;

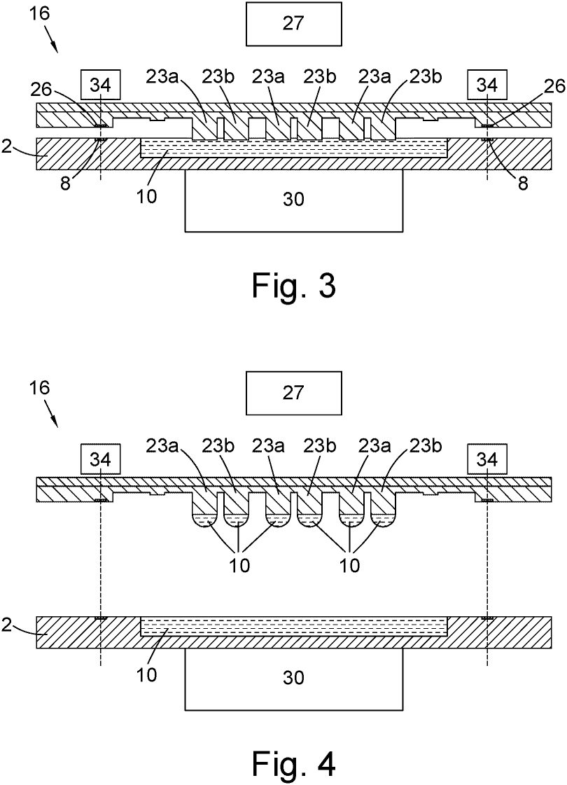

FIG. 3 schematically depicts in cross-section the transfer device with fingers of the transfer device in the liquid polymer;

FIG. 4 schematically depicts in cross-section the transfer device positioned above the tray, with liquid polymer on ends of the fingers of the transfer device;

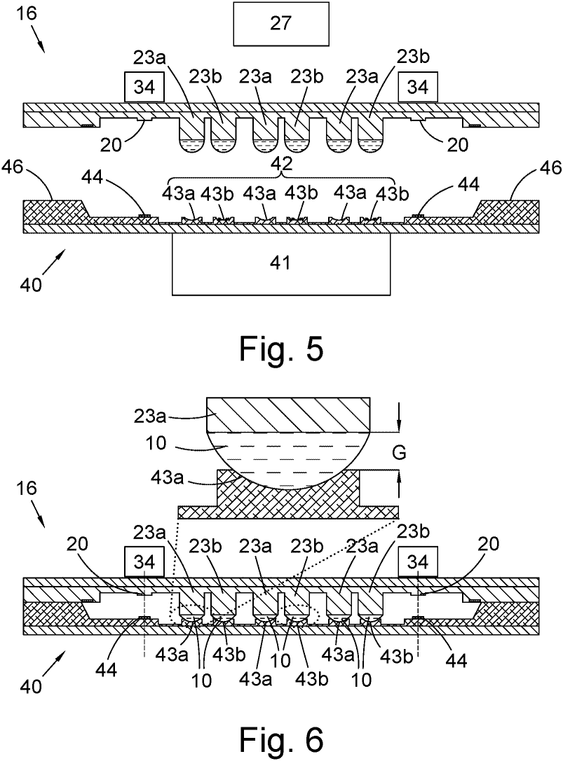

FIG. 5 schematically depicts in cross-section the transfer device positioned above a lens mold array;

FIG. 6 schematically depicts in cross-section the transfer device in proximity with the lens mold array such that liquid polymer is received in recesses of the lens mold array;

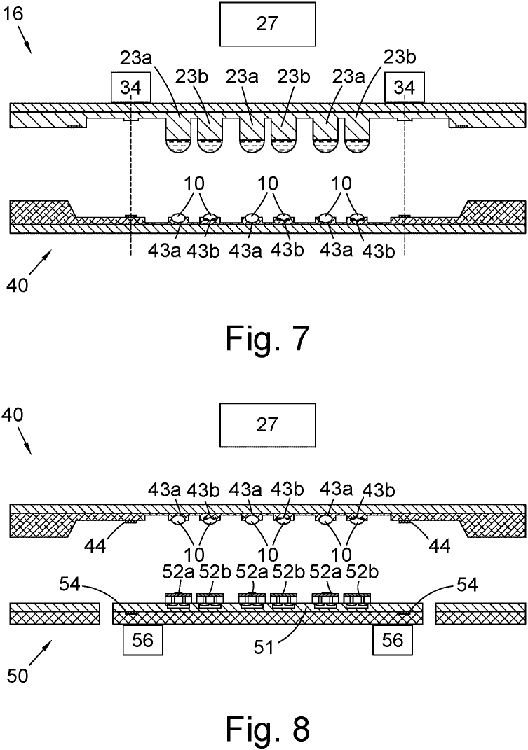

FIG. 7 schematically depicts in cross-section the transfer device positioned above the lens mold array, with liquid polymer having been transferred to the recesses of the lens mold array;

FIG. 8 schematically depicts in cross-section the lens mold array inverted and positioned over an array of optical devices;

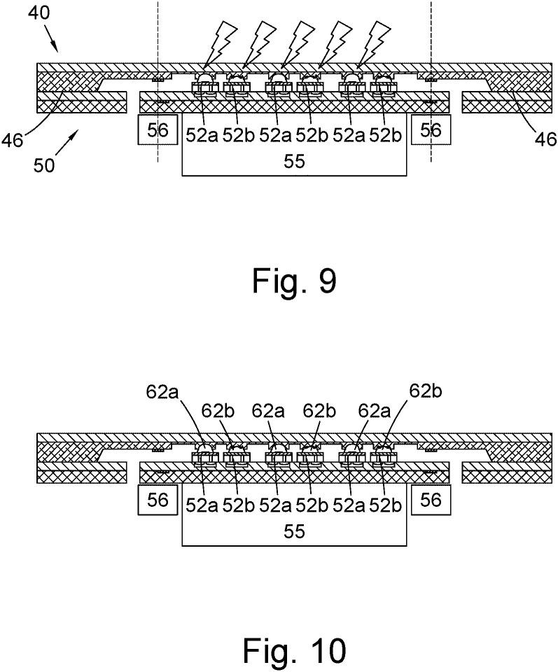

FIG. 9 schematically depicts in cross-section the lens mold array in proximity with the array of optical devices such that liquid polymer contacts the array of optical devices;

FIG. 10 schematically depicts in cross-section the lens mold array in proximity with the array of optical devices and with cured lenses formed on the optical devices;

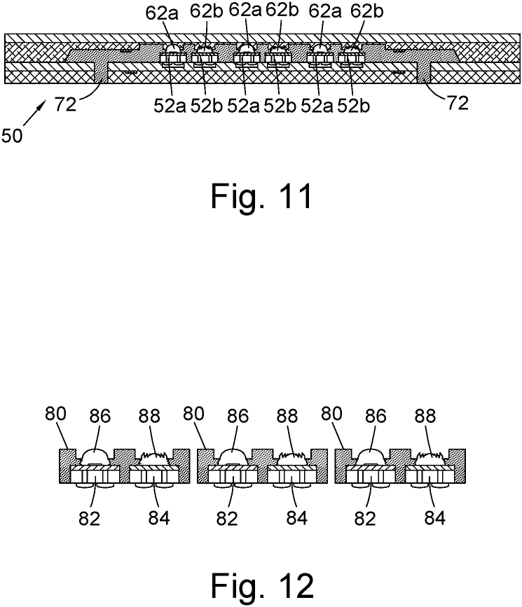

FIG. 11 schematically depicts in cross-section the lens mold array in proximity with the array of optical devices, and with opaque polymer having been injected between them; and

FIG. 12 schematically depicts in cross-section completed packaged optical modules comprising optical devices and lenses surrounded by opaque polymer.

### DETAILED DESCRIPTION OF THE PREFERRED EMBODIMENTS

Generally speaking, the disclosure provides a manufacturing method in which an array of lens-forming molds are filled simultaneously with liquid polymer using an array of fingers.

Some examples of the solution are given in the accompanying Figures.

FIG. 1 schematically depicts in cross-section a tray 2 provided with a recess 4. The tray 2 has a generally flat upper surface 6 either side of the recess 4. Alignment marks 8 are provided on the upper surface 6 of the tray 2 either side of the recess 4.

The tray 2 may be generally rectangular when viewed from above (not depicted). The recess 4 may be generally rectangular when viewed from above. The alignment marks 8 may be provided on each side of the recess 4. The alignment marks 8 allow the tray 2 to be aligned with other apparatus as is explained further below, and may be referred to as tray alignment marks 8.

Liquid polymer 10 is deposited into the recess 4 of the tray 2 (e.g. via an injection nozzle). An amount of liquid polymer 10 which is sufficient to over-fill the tray may be provided. That is, some of the liquid polymer 10 may project up beyond the top of the recess 4. A blade 12 is dragged across the recess 4 to remove excess liquid polymer. In FIG. 1, the blade 12 has been dragged across the recess and excess liquid polymer 14 has been removed from above the recess 4. The excess liquid polymer may be moved off the tray 2 using the blade 12. This ensures that the excess epoxy resin does not interfere with subsequent parts of the method.

The liquid polymer may for example be clear glue (e.g. UV curing glue). The liquid polymer may for example be clear liquid epoxy. The liquid polymer, when cured, should form a transparent solid (it will form lenses). For this reason the liquid polymer may be clear (transparent). The liquid polymer may have significant viscosity (i.e. may be more viscous than water such that peaks may be formed in the surface of the liquid polymer which do not immediately disappear). The liquid polymer may be referred to as a gel.

Over-filling the recess 4 and using the blade 12 to remove excess liquid polymer 10 is advantageous because it ensures that the recess 4 is full for subsequent parts of the method. It also ensures that the liquid polymer has a flat upper surface (the liquid polymer is more viscous than for example water and will not have a flat upper surface immediately after the recess has been filled). Ensuring that the recess 4 is full and has a flat upper surface avoids variation between amounts of epoxy resin provided to optical devices which could otherwise occur if this was not done.

Although the tray 2 is depicted as having a flat upper surface, it is not essential that the upper surface of the tray is flat. It may be desirable to have a flat upper surface area on at least one side of the recess 4 in order to allow the blade 12 to easily move excess liquid polymer from the recess onto the upper surface.

Although the recess 4 is described as being rectangular when viewed from above, the recess may have some other shape. The recess 4 should be dimensioned to be able to receive fingers of a liquid polymer transfer device as described below. Although the recess 4 is provided in a tray 2 in the illustrated embodiment, in other embodiments the recess may be provided in any suitable support structure.

FIG. 2 depicts in cross-section the tray 2 filled with liquid polymer 10. A liquid polymer transfer device 16 is positioned above the tray 2. For simplicity the liquid polymer transfer device is referred to as the transfer device 16. The transfer device 16 may be moved into position above the tray 2 using any suitable means. For example, the transfer device 16 may be provided on a rail or rails which may allow the transfer device to be moved horizontally. Alternatively, the tray 2 may be moved into position beneath the liquid polymer transfer device 16 (using any suitable means such as a rail or rails). For ease of reference, Cartesian coordinates are indicated in FIG. 2 and other figures, with z indicating the vertical direction. In this embodiment the transfer device 16 is movable in the x-direction (e.g. along a rail or rails).

The transfer device 16 comprises an array of fingers 18 which project downwardly from a substrate 19. The array of fingers 18 is integrally formed with the substrate 19. The array of fingers 18 and the substrate 19 may for example be formed from PDMS, another silicone or other suitable material. The substrate 19 is attached to a support 21. The support 21 may for example be formed from glass or other suitable material. The support 21 may be optically transparent.

The array of fingers 18 is a two dimensional array (e.g. a rectangular array). Although only six fingers 23a, b are depicted, in practice many more fingers may be provided. For example, the array of fingers 18 may comprise at least one thousand fingers. The array of fingers 18 may comprise at least five thousand fingers. The array of fingers 18 may comprise more than seven thousand fingers.

Fingers of the array 18 may have a diameter of 1000 microns or less, e.g. 500 microns or less. Fingers of the array 18 may have a diameter of 100 microns or more (e.g. 200 microns or more). The finger diameter may generally correspond with the diameter of a lens mold into which the finger is to transfer liquid polymer (see further below).

The fingers 23a, b may be cylindrical when viewed from below. The fingers 23a, b may have some other cross-sectional shape (e.g. rectangle hexagon, octagon, etc.). Where this is the case, the diameter values referred to above may apply instead to a maximum cross-sectional dimension of a finger. Cylindrically shaped fingers 23a,b are preferred because this matches with the shapes of lens mold recess into which the fingers are to transfer the liquid polymer. Distal ends of the fingers 23a,b may have flat surfaces (as depicted).

In this embodiment the fingers 23a, b are not equally spaced from each other. Instead, they are provided in pairs 23a, b. A separation s between each pair of fingers 23a,b is greater than a separation S between a first finger 23a and a second finger 23b of each pair. The positions of the fingers 23a, b are matched to positions of lens molds into which the fingers will transfer liquid polymer (as described further below). The separation s between fingers of a pair 23a, b may for example be 1000 microns or less, e.g. 500 microns or less. The separation s may for example be 200 microns or less. The separation s may for example be 100 microns or more. The separation S between pairs of fingers may for example be 5 mm or less. The separation S may for example be 2 mm or less. The separation S may for example be 1 mm or more. Separations as expressed herein may refer to the distance from the centre of a finger 18 to the centre of another finger.

The fingers of a pair may have the same maximum cross-sectional dimension or may have different cross-sectional dimensions. When the fingers are cylinders, the fingers of a pair may have the same maximum diameter or may have different maximum diameters. The fingers of a pair may have the same length or may have different lengths. Distal ends of the fingers of a pair may have the same height or may have different heights. Similarly, a pair of recesses in a lens mold array (described below) may have different dimensions. Providing the fingers with different cross-sectional dimensions (diameters) and/or lengths may allow for differently shaped lenses to be formed (e.g. in combination with recesses of a lens mold array having different shapes). For example, for an optical device which comprises an emitter and a sensor, the lens provided on the emitter may have a different shape than the lens provided on the sensor.

The transfer device further comprises alignment marks 20 which are provided on the substrate 19. These alignment marks 20 are used to align the transfer device 16 with a mold array 20 as is described further below. For this reason, the alignment marks 20 are referred to transfer device to mold alignment marks 20. The transfer device substrate 19 has a generally flat lower surface 22, excluding the fingers 18 and the alignment marks 20.

At either end of the substrate 19 of the transfer device 16 a downwardly projecting portion 24 is provided. These downwardly projecting portions 24 may extend fully around a perimeter of the transfer device 16 when viewed from below, or may extend partially around the perimeter of the transfer device 16. In some embodiments downwardly projecting portions 24 may be provided on all sides of the transfer device 16, or may be provided on only some sides of the transfer device 16. Downwardly projecting portions 24 may be provided in corners of the transfer device 16. As is explained further below, the downwardly projecting portion(s) 24 acts to control the vertical position of the fingers 18 relative to a lens mold array via engagement with upwardly projecting portions of the lens mold array.

Alignment marks 26 are provided in the downwardly projecting portions 24 (although in other embodiments they may be provided elsewhere). These alignment marks 26 are configured to align with the tray alignment marks 8 and may be referred to as transfer device to tray alignment marks 26. Image sensors 34 or other optical sensors look through the transfer device 16 (which is transparent) and can see the tray alignment marks 8 and the transfer device to epoxy tray alignment marks 26. The alignment marks may be used to control horizontal movement of the transfer device 16 (e.g. in the x-direction), stopping movement when horizontal alignment is observed. Aligning the transfer device 16 and the tray 2 ensures that all of the fingers of the array 18 enter the recess 4 of the tray correctly (for example ensuring that the fingers do not accidently strike a portion of the tray which is not recessed). Movement of the transfer device 16 (and movement of other apparatus) maybe controlled by a controller 27 based upon outputs from the image sensors 34 or other optical sensors.

FIG. 3 schematically depicts the liquid polymer transfer device 16 and the tray 2 in cross-section. In FIG. 3 an actuator 30 such as a stepper motor has been used to move the tray 2 upwards such that ends of the fingers of the array 18 are in the liquid polymer 10. A laser interferometer, or other distance measuring apparatus (not depicted) is used to monitor the separation between the tray 2 and the transfer device 16, and to stop movement when the ends of the fingers are in the liquid polymer 10. The actuator 30 may be controlled by the controller 27.

In addition to moving the tray 2 upwards, the actuator 30 may also be able to move the tray horizontally, and to rotate the tray, in order to achieve alignment of the tray and the transfer device 16.

As depicted in FIG. 4, the tray 2 is moved downwardly and away from the transfer device 16 by the actuator 30. Liquid polymer 10 remains on the end of each finger 18 due to adhesion and surface tension when the tray 2 is lowered from the transfer device 16.

Referring to FIG. 5, the transfer device 16 is located over an inverted lens mold array 40. The transfer device 16 may be moved to this position, for example along a rail or rails.

The lens mold array 40 comprises an array of recesses 42. The array of recesses 42 may be a rectangular array. Recesses 43a, b of the array 42 have the shape of lenses. The lenses may be conventional lenses and/or may be Fresnel lenses. As with the array of fingers 18, recesses of the array 42 may have a diameter of 1000 microns or less (e.g. 500 microns or less). Recesses of the array 42 may have a diameter of 100 microns or more (e.g. 200 microns or more).

In this embodiment the recesses 43a, b are not equally spaced from each other. Instead, they are provided in pairs 43a, b. A separation between each pair of recesses 43a, b is greater than a separation between a first recess 43a and a second recess 43b of each pair. The separation between recesses of a pair 43a,b may for example be 1000 microns or less (e.g. 500 microns or less). The separation may for example be 200 microns or less. The separation may for example be 100 microns or more. The separation may for example be 150 microns. The separation between pairs of recesses may for example be 5 mm or less. The separation may for example be 2 mm or less. The separation may for example be 1 mm or more.

Recesses 43a, b, of the lens mold array 40 are formed in projections 45 which project from a substrate 47. The projections 45 are integrally formed with the substrate 47. The projections 45 and the substrate 47 may for example be formed from PDMS, another silicone or other suitable material. The substrate 47 is attached to a support 49. The support 49 may for example be formed from glass or other suitable material. The support 49 may be optically transparent. The projections 45 may be formed by etching into the substrate 47 around the projections.

The substrate 47 of the lens mold array 40 is provided with alignment marks 44, referred to here as mold array alignment marks. As with other apparatus disclosed herein, two alignment marks 44 are visible. However, more than two alignment marks may be provided (the same may apply for other alignment marks in this disclosure). The mold array alignment marks 44 are configured to align with the transfer device to mold array alignment marks 20 provided on the transfer device 16.

Raised portions 46 are provided at either end of the lens mold array 40. The raised portions 46 are configured to receive the downwardly projecting portions 24 of the transfer device 16. The raised portions 46 may extend fully around a perimeter of the lens mold array 40 when viewed from above, or may extend partially around the perimeter of the lens mold array 40. In some embodiments raised portions 24 may be provided on all sides of the lens mold array 40, or may be provided on only some sides of the lens mold array. Raised portions 24 may be provided in corners of the transfer device 16. In general, the raised portions 24 may be provided at any location outside of the array of recesses. The downwardly projecting portions 24 of the transfer device 16 may be provided at corresponding locations so that they engage with the raised portions 24.

An actuator 41 supports the lens mold array 40. The actuator 41 is configured to provide horizontal and vertical movement of the lens mold array 40, and also to rotate the lens mold array. The actuator 41 may be controlled by the controller 27. The lens mold array 40 may be moved until the lens mold array alignment marks 44 are aligned with the transfer device to mold alignment marks 20. The image sensors 34 or other optical sensors may be moved so that they are over the transfer device to mold alignment marks 20 and may look through these to the lens mold array alignment marks 44. In other embodiments other image sensors or optical sensors may be used.

Referring to FIG. 6, the lens mold array 40 is moved upwardly by the actuator 41 until a desired separation between the fingers 23a, b and the recesses 43a, b is achieved. The desired separation may be of the order of tens of microns (e.g. 50 microns). The separation may be monitored using an interferometer or other gap measuring tool (e.g. by measuring the separation between the raised portion 46 of the lens mold array 40 and the downwardly projecting portion 24 of the transfer device 16). The gap between the fingers 23a, b and the recesses 43a, b is controlled because the combined heights of the fingers and the recesses relative to the combined heights of the raised portion 46 and downwardly projecting portion 24 are known. Avoiding contact between the fingers 18 and the recesses 43a, b is advantageous because this avoids the possibility of the fingers 18 causing damage or wear to the recesses 43ab.

As may be seen in FIG. 6, the fingers 23a, b do not come into contact with the recesses 43a, b. Instead there is a gap G between the fingers and the recesses. This is depicted in an enlarged view of part of a finger 32a and recess 43a in FIG. 6. The gap G may for example be 40 microns or more. The gap G may be measured between a lowermost end of a finger and an uppermost surface of a lens recess mold 43a. The uppermost surface of a lens mold recess 43a, b may be considered to be an uppermost surface of a projection 45 from the substrate 47 in which the recess is formed.

Because the liquid polymer 10 extends downwardly from the fingers 18a,b, the liquid polymer comes into contact with the recesses 42a, b. Capillary action (or other adhesion force) draws the liquid polymer into the recesses 42a, b. In general, ends of the fingers 23a, b may be brought into proximity with the recesses 43a, b without them touching each other.

The lens mold array 40 is then lowered down and away from the lens mold array 40 as depicted in FIG. 7. As is depicted in FIG. 7, some liquid polymer 10 is retained in the recesses 43a, b. A smaller amount of liquid polymer 10 may remain on the fingers 23a, b.

It is desirable to provide sufficient liquid polymer 10 in the recesses 43a, b such that the liquid polymer projects above an uppermost surface of the recesses (e.g. by at least 80 microns, e.g. by 100 microns or more). This is so that the liquid polymer contacts optical device surfaces correctly and therefore forms lenses correctly (as described further below).

In order to achieve projection of the liquid polymer 10 above the recesses 43a, b (e.g. by at least 80 microns), the transfer device 16 may be used to transfer liquid polymer to the lens mold array 40 multiple times. The transfer device 16 may be moved back to the tray 2, the array of fingers 18 again be dipped into liquid polymer held by the tray and then brought into proximity with the mold array 40 to allow transfer of further liquid polymer into the molds. Transfer of liquid polymer 10 into the recesses 43a, b may be performed multiple times until a desired height of liquid polymer is achieved.

In order to increase the height of the liquid polymer 10 projecting out of the recesses 43a, b, the gap between the fingers 23a, b and the recesses may be increased for successive transfers of liquid polymer from the transfer device 16 to the mold array 40. Four or more transfers of liquid polymer 10 from the transfer device 16 to the mold array 40 may take place. A first transfer may have a gap of 50 microns between the fingers 23a, b and the recesses 43a, b, a second transfer may have a gap of 70 microns, a third transfer may have a gap of 100 microns, and a fourth transfer may have a gap of 150 microns. This may provide liquid polymer 10 which projects above an uppermost surface of the recesses 43a, b by around 125 microns.

Other sizes of gap G may be used. The minimum gap size may be 40 microns. The maximum gap size may depend at least in part on the height of a lens which is to be formed using the liquid polymer.

In general, the transfer of liquid polymer from the transfer device 16 to the mold array 40 may be performed multiple times (e.g. a series of three or more times). In general, the gap between the fingers 23a, b and the recesses 43a, b for a given transfer may be larger than the gap for the preceding transfer (e.g. by at least 10 microns, or by at least 20 microns). When a series of transfers of liquid polymer are performed, the gap may be larger for each transfer of the series. When a series of transfers of liquid polymer are performed, the size of the gap may be increased by a larger amount for each transfer of the series (compared with the size of the gap for the preceding transfer).

The height of the liquid polymer 10 projecting from the recesses 43a, b when a series of transfers has been performed may be known from prior experimentation and/or calibration. For this reason, it may not be necessary to monitor the height of the liquid polymer 10 projecting from the recesses 43a, b (although this may be done if desired, for example using an image sensor which looks at one or more recesses).

Referring to FIG. 8, once a desired number of transfers of liquid polymer 10 to the lens mold array 40 have been performed, the lens mold array is inverted. Adhesion force and surface tension holds the liquid polymer in place in the recesses 43a, b of the lens mold array 40. An array of optical devices 50 is positioned beneath the lens mold array 40 (e.g. using a rail or rails). Optical devices 52 of the array may be emitters 52a and sensors 52b provided as pairs. The substrate 51 is provided with alignment marks 54 which correspond in position with the lens mold array alignment marks 44.

The actuator 41 may be used to adjust the horizontal position of the lens mold array 40 until the alignment marks 44, 54 are aligned. Alignment may be measured using image sensors 56 located beneath the substrate 51. Adjustment of the position of the lens mold array 40 using the actuator 41 may be controlled by the controller 27.

Referring to FIG. 9, the array of optical devices is moved upwards and into contact with the substrate 51 (e.g. using an actuator 55). Raised portions 46 of the lens mold array 40 contact the substrate. As depicted, the recesses 43a, b do not come into contact with the optical devices 52a, b. Instead, the recesses 43a, b are brought into proximity with the optical devices 52a, b. A gap is present between the recesses 43a, b and the optical devices 52a, b. The size of the gap may be controlled by selection of the height of the raised portion 46. The optical devices 52a, b may include wire bonds which extend beyond an upper surface of the devices. The gap may ensure that the recesses 43a,b of the lens mold array 40 do not contact the wire bonds (such contact could damage the wire bonds). The gap may for example be 50 microns or more.

Because the gap between the recesses 43a, b and the optical devices 52a, b is smaller than the distance by which the liquid polymer 10 projects out of the recesses, the liquid polymer comes into contact with the optical devices. The liquid polymer 10 spreads out across an uppermost surface of the optical devices 52a, b (although it may stop spreading before it reaches edges of the devices).

The degree to which the liquid polymer 10 spreads across the devices is determined the distance by which the liquid polymer 10 projects out of the recesses 43a, b. In a conventional method, each recess is filled in series. As a result, by the time the last recess is filled the liquid polymer has been present in the first recess for a considerable period of time (e.g. an hour or more). During this time the liquid polymer 10 will gradually spread outwards across an uppermost surface of the recess, and its height will be reduced. Consequently, during transfer to an optical device, that liquid polymer will spread to an undesirable extent across the surface of the device (and may even flow over sides of the device). As a result, an aperture formed around the lens (described below) may not be formed correctly. These problems are avoided by embodiments of the disclosure, because the recesses 43a,b are filled in parallel and not in series, and this allows the liquid polymer to be provided in the recesses with a controlled height. Thus, as depicted in FIG. 9, liquid polymer forms well controlled lens shapes on the optical devices 52a,b. Flowing of liquid polymer over sides of the optical devices 52a,b may be avoided. Flow of liquid polymer over the sides of an optical device may be referred to as overspill.

As also depicted in FIG. 9, ultraviolet light 60 is directed through the lens mold array 40. The ultraviolet light 60 cures the liquid polymer 10 such that it is converted into a solid. The liquid polymer is transparent and remains transparent when it solidifies. Thus, as depicted in FIG. 10, transparent lenses 62a, b with shapes determined by the molds 42 are formed on the optical devices 52a, b. The optical devices 52a, b together with the lenses 62a, b may be referred to as optical modules. Other forms of curing (e.g. heat) may be used in addition to or instead of ultraviolet light.

Referring to FIG. 11 vacuum injection molding is used to inject opaque material 70, such as an opaque polymer, into spaces around the devices 56 via openings 72 in the substrate 51. The opaque polymer is then cured (e.g. using UV light and using heat). The opaque material 70 forms a cover which surrounds each device (but does not cover the lens 62a, b), thereby protecting the device and preventing stray light from entering the device. The opaque material 70 forms an aperture around each lens 62a, b. Because the lenses 62a, b have well controlled shapes, the apertures have well controlled sizes. If the lenses 62a, b had poorly controlled shapes, for example because some liquid polymer 10 had flowed over sides of the optical devices 52a, b, then the apertures may have incorrect sizes. For example, a lens may have a reduced diameter and as a consequence the aperture formed around that lens may also have a reduced diameter. This will cause poor performance of the optical device. Embodiments of the disclosure may avoid this problem.

Once the opaque material 70 has solidified, the lens mold array 40 is raised upwards and away from the device array 50. The lens mold array 40 may be reused.

The optical modules and surrounding polymer are separated from the supporting substrate 52 (e.g. using a suitable solvent) and are then diced. The resulting packaged optical modules 80 are depicted in FIG. 12.

In this instance each packaged optical module 80 comprises an emitter 82 and a sensor 84 provided as a pair. A lens 86 is provided on the emitter 82 and a lens 88 is provided on the sensor 84.

In an alternative embodiment the optical module may comprise a single lens provided on a single optical device (e.g. a sensor). Fabrication of the optical module may be as described above, except that the transfer device fingers are not provided in pairs and the recesses of the lens mold are not provided in pairs (instead they may be equally spaced).

In general, the fingers of the transfer device may be regularly spaced. The fingers of the transfer device may have any spacing, although the spacing should correspond with spacing of recesses in a lens mould array.

In the above description various references are made to moving one apparatus relative to another. For example, there are references to moving the tray 2 vertically relative to the transfer device 16. Where this is the case, in alternative arrangements the apparatus which is referred to as moving may remain still with the other apparatus moving instead (e.g. the transfer device 16 may move vertically relative to the tray 2). Both apparatus may be moved (e.g. the transfer device 16 and the tray 2 may move vertically towards each other), although this may be more expensive to implement.

Embodiments of the disclosure advantageously may allow lenses to be fabricated with a desired shape more consistently than using conventional fabrication techniques. Embodiments of the disclosure advantageously may allow lenses to be fabricated with a desired size and height more consistently than using conventional fabrication techniques.

Optical modules formed using an embodiment of the present disclosure can be employed in many different applications including, for example, in the mobile phone industry and other industries.

Optical modules formed using an embodiment of the present disclosure may form part of a smartphone, a tablet computer, a laptop computer, a computer monitor, a car dashboard and/or navigation system, an interactive display in a public space, a home assistant, etc.

List of reference numerals

| | |
|---|---|
| 2 | Tray |
| 4 | Recess |
| 6 | Tray upper surface |
| 8 | Tray alignment marks |
| 10 | Liquid polymer |
| 12 | Blade |
| 14 | Excess liquid polymer |
| 16 | Transfer device |
| 18 | Array of fingers |
| 19 | Substrate |
| 20 | Transfer device to mold alignment marks |
| 21 | Substrate lower surface |
| 23a,b | Fingers of the array |
| 24 | Downwardly projecting portions of substrate |
| 26 | Transfer device to tray alignment marks |
| 27 | Controller |
| 30 | Actuator |
| 34 | Image sensors |
| 40 | Lens mold array |
| 42 | Array of recesses |
| 41 | Actuator |
| 43a,b | Recesses of the array |
| 44 | Mold array alignment marks 44 |
| 46 | Raised portions |
| 50 | Array of optical devices |
| 51 | Substrate |
| 52a,b | Optical devices of the array |
| 54 | Substrate alignment marks |
| 55 | Actuator |
| 56 | Image sensors Marks & Clerk LLP |
| 60 | Ultraviolet light |
| 62a,b | Transparent lenses |
| 70 | Opaque material |
| 72 | Substrate openings |
| 80 | Optical module |
| 82 | Emitter |
| 84 | Sensor |
| 86 | Lens |
| 88 | Lens |

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. A method of producing optical modules comprising:
transferring liquid polymer to a lens mold array by dipping an array of fingers of a transfer device into a liquid polymer, bringing the array of fingers into proximity with recesses of the lens mold array so that the liquid polymer is received in the recesses, then separating the array of fingers and the lens mold array so that liquid polymer is retained in the recesses; and
forming lenses on optical devices by bringing the lens mold array into proximity with the array of optical devices so that the liquid polymer contacts a surface of the optical devices, and curing the liquid polymer to form the lenses on the optical devices.

2. The method of claim 1, further comprising transferring the liquid polymer to the lens mold array multiple times before forming the lenses on the optical devices.

3. The method of claim 2, wherein the transfer of liquid polymer is performed for a series of three or more times.

4. The method of claim 1, wherein when the array of fingers are in proximity with recesses of the lens mold array, there is a gap of at least 40 microns between ends of the fingers and uppermost surfaces of the recesses.

5. The method of claim 1, wherein when the array of fingers are in proximity with recesses of the lens mold array, there is a gap of up to 200 microns between ends of the fingers and uppermost surfaces of the recesses.

6. The method of claim 2, wherein when the array of fingers are in proximity with recesses of the lens mold array, there is a gap between ends of the fingers and uppermost surfaces of the recesses, and wherein for a given transfer the gap between ends of the fingers and uppermost surfaces of the recesses is larger than for a preceding transfer.

7. The method of claim 6, wherein the gap is at least 20 microns greater than the preceding gap.

8. The method of claim 3, wherein when the array of fingers are in proximity with recesses of the lens mold array, there is a gap between ends of the fingers and uppermost surfaces of the recesses, and wherein for each transfer of the series of transfers, the gap between ends of the fingers and uppermost surfaces of the recesses is larger than for the preceding transfer of the series.

9. The method of claim 8, wherein the the size of the gap is increased by a larger amount for each transfer of the series, compared with the size of the gap for the preceding transfer of the series.

10. The method of claim 1, wherein when the transfer of liquid polymer has been completed, the liquid polymer projects beyond uppermost surfaces of the recesses of the lens mold array by at least 80 microns.

11. The method of claim 1, wherein the array of fingers is a two dimensional array.

12. The method of claim 11, wherein the array of fingers comprises at least one thousand fingers.

13. The method of claim 1, wherein distal ends of the fingers have flat surfaces.

14. (canceled)

15. The method of claim 1, wherein the fingers have a maximum cross-sectional dimension of 1000 microns or less.

16-17. (canceled)

18. The method of claim 1, wherein the fingers are provided in pairs, with one finger of a pair having a distal end at a different height than the other finger of the pair.

19. The method of claim 1, wherein the fingers are provided in pairs, with one finger of a pair having a greater maximum cross-sectional diameter than the other finger of the pair.

20. (canceled)

21. The method of claim 1, wherein the method further comprises injecting an opaque polymer into spaces around the devices to form covers for the devices with apertures around the lenses, then dicing the opaque polymer covers to form packaged optical modules.

22. A liquid polymer transfer device comprising a substrate provided with a two dimensional array of fingers which project from a substrate and further comprising a plurality of alignment marks provided in the substrate.

23. An optical module comprising an optical device provided with a lens formed according to the method of claim 1.

24. The optical module of claim 23 wherein there is no overspill of cured polymer on sides of the optical device.
